(19) United States
(12) Patent Application Publication
(10) Pub. No.: US 2006/0019739 A1
(43) Pub. Date: Jan. 26, 2006

(54) Systems and methods for scanning gaming chips placed on a gaming table

(75) Inventors: Richard Soltys, Newcastle, WA (US); Richard Huizinga, Newcastle, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Bally Gaming International, Inc., Las Vegas, NV (US)

(21) Appl. No.: 11/107,368

(22) Filed: Apr. 15, 2005

Related U.S. Application Data
(60) Provisional application No. 60/562,796, filed on Apr. 15, 2004.

(51) Int. Cl. G06F 17/00

(52) U.S. Cl. 463/25

(57) ABSTRACT

A gaming environment comprising a gaming table and a number of optical scanners capable of scanning and decoding machine-readable symbols carried by wagers that are placed approximately within a wagering on the gaming table. The optical scanners operate over specific ranges to capture the reflective light from the wager while excluding reflective light from other objects that are not intended to be scanned. The optical scanners may be located in a chip tray near the dealer, in the gaming table, or in a dealer's podium adjacent to a gaming table. Periodic scans of the wagers can produce measurements and information relevant to security, real-time accounting, and providing a basis for automatically allocating player benefits.

### CROSS-REFERENCE TO RELATED APPLICATION

This application claims the benefit of U.S. Provisional Patent Application No. 60/562,796 filed on Apr. 15, 2004, which is incorporated herein by reference in its entirety.

### BACKGROUND OF THE INVENTION

1. Field of the Invention

This description generally relates to the field of wagering or gaming, and more particularly to monitoring the wagers of players at a gaming table.

2. Description of the Related Art

Gaming has enjoyed phenomenal growth over the recent past, with the addition of numerous forms of wager based gaming, the legalization of wagering in a large number of jurisdictions domestically and internationally, and the construction of numerous casinos to service the increasing demand for gaming opportunities.

Casinos provide a large variety of games and other forms of entertainment for their customers. For example, casinos may provide slot machines, as well as, table games such as blackjack, poker, craps, roulette, baccarat, big wheel or wheel of fortune, to name a few. Due to the large amounts of money, particularly cash involved in gaming, casinos must carefully monitor the activities of both players and casino employees. Careful and continuous monitoring of gaming activities not only enhances security, but also permits the better management of the casinos' business, for example, selecting the number and mix of tables, the hours of operation of various tables, staffing, etc.

Typically, a customer exchanges currency or some form of credit for a casino's chips. The customer places the chips as wagers at various games, such as blackjack, craps, roulette, and baccarat. A game operator, such as a dealer, pays out winning wagers with additional chips based on the set of odds for the particular game. The dealer collects the customer's chips for losing wagers. The odds of each game slightly favor the casino, so on average the casino wins and is profitable.

Like many businesses, casinos wish to understand the habits of their customers. Some casinos have employees visually observe customer's game play and may also manually track the gaming and wagering habits of the particular customers. The information allows the casinos to select the number of different games that the casino will provide and to adequately staff those games.

The fast pace and large sums of money make casinos likely targets for cheating and stealing. Casinos employ a variety of security measures to discourage cheating or stealing by both customers and employees. For example, surveillance cameras covering a gaming area or particular gaming table provide a live or taped video signal that security personnel can closely examine. Additionally, or alternatively, “pit managers” can visually monitor the live play at one or more gaming tables.

While some aspects of a casino's security system should be plainly visible as a deterrent, other aspects of the security should be unobtrusive to avoid detracting from the players' enjoyment of the game and to prevent cheaters and thieves from avoiding detection.

Some of the current tracking methods used by casinos have several drawbacks. One common method typically depends on manual observation of a gaming table. Thus coverage is not comprehensive, and is limited to tracking a relatively small number of games, customer's and employees. This problem is exacerbated by a customer's ability to rapidly move between gaming tables. Cheating customers may frequently switch tables to avoid detection. Manual observation is prone to error because the method relies on human observers who can become inattentive or distracted. In one commonly known method of cheating the casino, one member of a team will create a distraction while another member steals chips or swaps cards. Manual tracking methods are also labor intensive, requiring a large number of additional casino employees, who should also be monitored to reduce employee theft.

Another tracking method employs video cameras located at a gaming table to capture at least some of that tables gaming activities. However, the monitoring of a player's wagers with video cameras also has several drawbacks. For example, the resolution of video images can be adversely effected by changes in lighting conditions, which may be caused by shadows cast on the table, smoke in the casino, or a variety of other reasons. In addition, some casinos prefer to keep records of each gaming session for at least some amount of time afterward. Because large quantities of computing memory are necessary to store video images, the video images from a given session may be frequently overwritten.

Another tracking option is to embed optical imagers in close proximity to the wagering area, the area where a player places his or her chips when making a wager. Placing the optical imagers in close proximity to the wagering area may be necessary to obtain sufficient resolution of the player's chips. However, placing optical imagers such that they are visible on the table surface detracts from the traditional look and feel of a gaming table. In addition, any protuberance in the table caused by the optical imagers creates an impediment to the smooth flow of cards and chips between the dealer and the players, especially in a game like Baccarat where a card shoe is passed around from dealer, to player, to player.

### SUMMARY OF THE INVENTION

In one aspect, a wager monitoring system includes a gaming table having at least one delimited area to receive at least one object bearing a machine-readable symbol; and a scanner operable to receive light from the at least one object, if any, when the at least one object is located at least partially within a volume extending perpendicularly from the delimited area, the scanner further operable to produce a signal indicative of a reflectance profile of light, wherein the reflectance profile is resolvable if the light is received from the at least one object.

In another aspect, a method of reading information from a machine-readable symbol, the symbol carried by at least one wager, the method includes locating at least one optical scanning device distally from a wagering area on a gaming table; calibrating the optical scanning device to have a depth of field region configured to read the machine-readable symbol when the at least one wager is located approximately within the wagering area; projecting a light source toward at least a portion of the at least one wager; receiving at least some amount of light reflected from the at least one wager, the light modulated with information carried by the machine-readable symbol; and processing the amount of reflected light to decode the information from the machine-readable symbol.

In yet another aspect, a system for reading information from an object located on a gaming table includes at least one optical scanning device distally located from a wagering region on the gaming table, the optical scanning device calibrated to have a depth of field tailored to read a machine-readable symbol carried by the object when the object is located approximately within the wagering region; and a processor communicatively coupled with the optical scanning device for processing at least some of the light reflected from the object.

### BRIEF DESCRIPTION OF THE DRAWINGS

FIG. 1 is a top plan view of a gaming environment where a dealer and players play a game at a gaming table according to one illustrated embodiment.

FIG. 2 is a rear, top, right side, isometric view of the gaming environment of FIG. 1.

FIG. 3A is a top, front isometric view of a gaming chip carrying a machine-readable symbol according to one illustrated embodiment.

FIG. 3B is a front elevational view of the gaming chip of FIG. 3A.

FIG. 4 is a block diagram of a monitoring system for monitoring the gaming environment of FIG. 1 according to one illustrated embodiment.

FIG. 5 is a top, front, right side, isometric view of a chip tray according to one illustrated embodiment.

FIG. 6 is a top plan view of an interior of the chip tray of FIG. 5, having optical scanners and optical imagers located in the chip tray according to one embodiment of the invention.

FIG. 7 is a rear, top, right side isometric view of the gaming table of FIG. 1 illustrating two volumes of space that correspond to wagering areas.

FIG. 8 is a top, left side, isometric view of an optical scanner illustrating a symbol flooded with light from the reader.

FIG. 9 is a top plan view of a gaming environment having optical scanners located in the gaming table according to another illustrated embodiment.

FIG. 10 is a top plan view of a gaming environment having a gaming table and a dealer's podium with at least some automation equipment, such as optical scanners, according to one illustrated embodiment.

FIG. 11 is a top plan view of a gaming table configured to be retrofitted with a dealer's podium according to one illustrated embodiment.

FIG. 12 is a top plan view of a gaming table and a dealer's podium carrying suitable electronics according to still another illustrated embodiment.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with computers, computer networks, readers and machine-vision have not been shown or described in detail to avoid unnecessarily obscuring descriptions of the embodiments of the invention.

The headings provided herein are for convenience only and do not interpret the scope or meaning of the claimed invention. This description initially presents a general explanation of gaming and gaming table monitoring components in the environment of a blackjack table. A more specific description of each of the individual hardware components and the interaction of the hardware components follows.

Blackjack Gaming

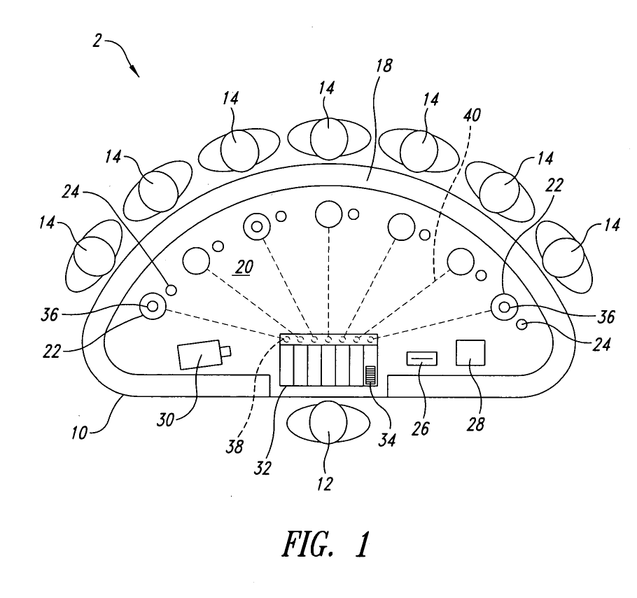

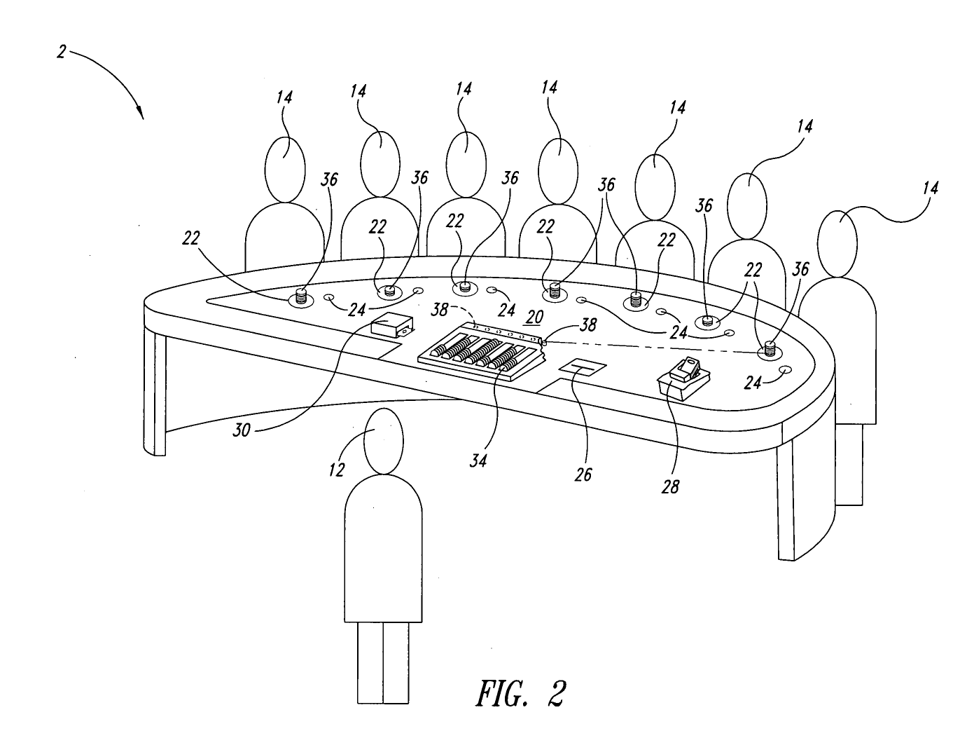

FIGS. 1 and 2 show a gaming environment 2 where a card game such as blackjack is played at a gaming table 10 by a game operator or dealer 12 and customers or players 14. While blackjack is used as an example, the teachings herein are generally applicable to a variety of wagering games, such as craps, baccarat, poker, wheel of fortune, and roulette to name only a few.

The gaming table 10 can have a padded rim 18, which gives the players 14 a place to lean or rest and which prevents items from being accidentally or surreptitiously slipped onto or off of the gaming table 10. The gaming table 10 can also have a felt-type covering 20 with printed symbols identifying areas on the table that have special purposes. For example, on a blackjack table 10, there are typically seven to nine player positions, each position associated with a respective wagering area or betting circle 22 delimited on the gaming table 10. A secondary wagering area 24 may also be delimited on the table surface 20 for the placement of insurance bets or double-down bets. Examples of making and installing gaming table covers are discussed in detail in U.S. Provisional Patent Application No. 60/517,297, filed on Nov. 3, 2003.

In addition to the features printed on the table surface 20, the table surface 20 may carry one or more devices, either being placed on the table or being affixed to the table. For devices that are affixed to the table 10, the fixture may be permanently affixed or selectively attachable/detachable. One such device that is generally formed with the gaming table 10 is a drop box 26, which receives a player's currency or marker when the player requests chips (i.e., “a buy in”). The drop box 26 is generally affixed under the table with access to the drop box 26 by the dealer 12 being a slot on the table surface 20.

Another device carried by the table surface 20 can be a discard reader 28. The discard reader 28 is configured to read (e.g., scan, image or otherwise) cards discarded by the player's during the game and/or at the conclusion of each game. The various operations and configurations of discard readers 28 are discussed in detail in U.S. Pat. No. 6,460,848, issued on Oct. 8, 2002, in U.S. Pat. No. 6,652,379, issued on Nov. 25, 2003, and in U.S. Pat. No. 6,685,568, issued on Feb. 3, 2004.

Yet, another device is a card shoe 30, from which the dealer 12 removes cards to deal the game. The dealer 12 can individually draw the cards from the card shoe 30, or can remove an entire set of cards from the card shoe 30, for example to deal from a hand-held deck. Many players 14 appreciate the experience of a game where the cards are dealt from a deck held by the dealer 12, rather than being individually drawn from the card shoe 30. In one embodiment, the card shoe 30 is configured to electronically communicate with a casino computing system (discussed below) and the discard reader 28. Card shoes 30 include optical imagers or optical scanners to read at least some of the cards placed in the card shoe 30. Specific details regarding various operations and configurations of a card shoe 30 are discussed in U.S. Pat. No. 6,460,848, issued on Oct. 8, 2002, U.S. Provisional Patent Application No. 60/500,898, filed on Sep. 5, 2003; U.S. Provisional Patent Application No. 60/501,489, filed on Sep. 8, 2003; and U.S. Provisional Patent Application No. 60/511,931, filed on Oct. 16, 2003.

As shown in FIG. 2, the players 14 place a number of chips 36 in the betting circles 22 as a wager 36. The wagered chips 36 typically come in a variety of denominations and are encoded with machine-readable indicia, as explained in detail below. The players 14 receive chips in exchange for currency or credit by the casino's tellers or dealers. Casinos typically require the use of chips 36 for wagering, rather than actual currency.

At the end of a “hand” or game, the dealer 12 collects the wagered chips 36 from the losing players and pays out winnings from the casino's inventory of chips 36 to any winning players. The dealer 12 places the chips 36 collected from the losing players into a gaming table bank that takes the form of a chip tray 32, according to the illustrated embodiment. The dealer 12 then pays but the winnings using the required number of chips 36 from the chip tray 32. The chip tray 32 generally consists of a number of wells configured to receive chips 38 having different chip denominations. Changes to the contents of the chip tray 32 represent the winnings and loses of the casino (“house”) at that particular gaming table 10. Thus, maintaining an accurate count of the number and value of the chips 36 in the chip tray 32 can assist the casino in managing its operations. Many casinos permit the dealer 12 to exchange chips for items of value such as currency or other items at the gaming table 10. The dealer 12 deposits the item of value into the drop box 26. Periodically, for example at the end of a dealer's shift, the contents of the drop box 26 must be reconciled with contents of the chip tray 32, to ascertain that the correct number and value of chips were distributed and collected.

One way for casinos to more accurately track the chips 36 wagered by the players 14 during a game is to periodically survey the table 10 and determine a value of each player's wager 36. The player's wager 36 may be a single chip or more than one chip, in which case most casinos request that the players place multiple chips 36 in a stack. In one embodiment, surveying the gaming table 10 can be accomplished with optical scanners 38 located in the chip tray 32, as illustrated in FIGS. 1 and 2. In one embodiment, the optical scanners 38 use a focused light beam that is sequentially scanned across the wagered chips 36 to read any machine-readable indicia located thereon.

Chips

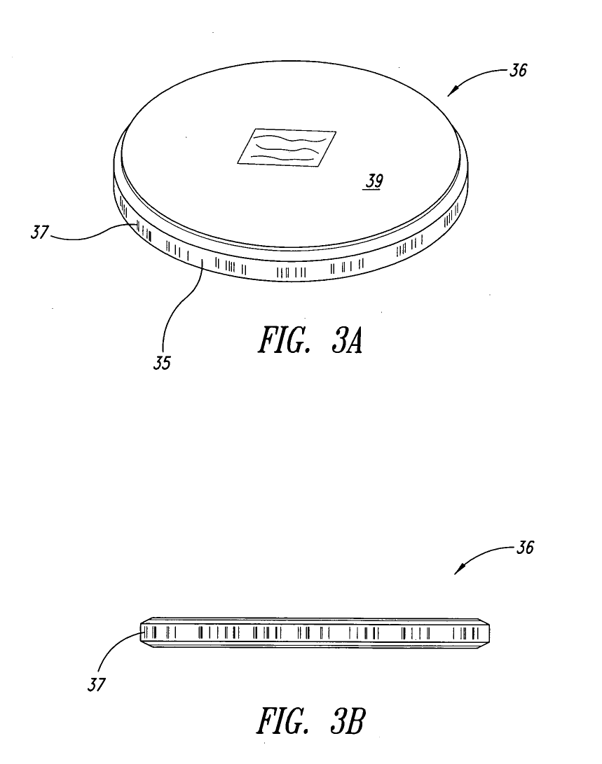

FIGS. 3A and 3B show that the chips 36 are formed as circular disks in which the denomination of the chip is visually represented by at least a color of the chip and may also be depicted with a numeric marking on the face 39 of the chip 36. The gaming chips 36 include encoded information located on at least a circumferential edge 35 of the chip 36 according to the illustrated embodiment. The encoded information is human-readable information and/or at least one machine-readable indicia 37. The information is located on the upper chip surface 39, the lower chip surface, or the circumferential edge 35 of the chip 36, according to one embodiment. The information can include data that identifies the issuing casino, the denomination, and/or a unique serial number.

The machine-readable indicia 37 is a bar code, an area or matrix code, or a stacked code according to one embodiment. Bar codes, for example, have optically contrasting stripes that can be read by optical scanners. Thus, in one embodiment, the portions of the chip 36 carrying the machine-readable indicia 37 should have diffuse reflectance characteristics, which cause light to be reflected in all directions. Such diffuse reflectance characteristics are contrasted with specular reflectance characteristics, which cause a beam of light to be reflected at a specific angle to the surface. In addition, the machine-readable indicia 37 can be printed using ink that is not typically visible to humans, such as ink that is only visible in the infrared portion of the electromagnetic spectrum.

U.S. Patents to Fisher et al., U.S. Pat. No. 5,103,081, to Schubert, U.S. Pat. No. 6,313,871, disclose systems for capturing video images of gaming chips, which may have encoded information. U.S. Patent to Storch, U.S. Pat. No. 6,514,140, discloses systems for capturing still images of gaming chips, where the cameras are located in turrets on the gaming table surface and in close proximity to the wagering areas on the gaming table.

Methods of making and encoding uniquely identifiable gaming chips 36 are described in U.S. Provisional Patent Application No. 60/490,072, filed on Jul. 25, 2003. Even if the chips 36 are not uniquely encoded as discussed in the reference application, the chips 36 may still carry the machine-readable indicia 37 that identifies at least the denomination of the chip 36. One skilled in the art will understand and appreciate that there are many ways to place machine-readable indicia 37 onto gaming chips 36 and there are many types of chips, whether clay, plastic, or some other material that can accept machine-readable indicia 37.

System Overview

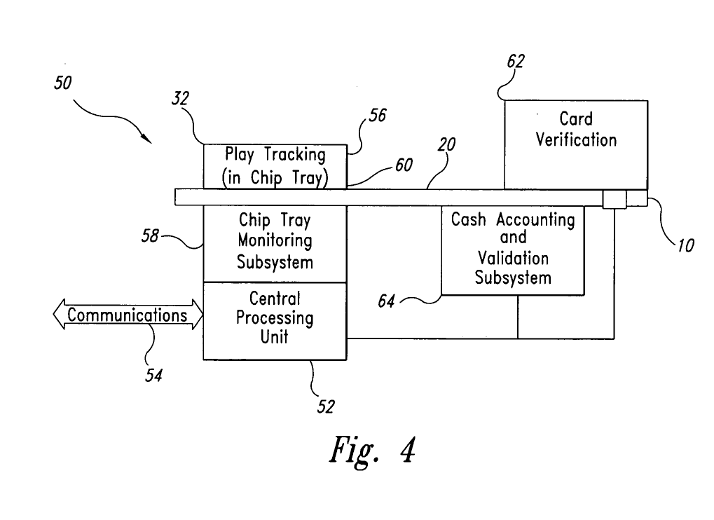

As shown in FIG. 4, a monitoring system 50 is provided for tracking the wagering and play at a gaming table, such as the blackjack gaming table 10. The monitoring system 50 includes a number of component subsystems coupled together by a central processing unit (“CPU”) 52 for the gaming table 10. The gaming table CPU 52 can take the form of a programmed general purpose computer, and/or a specialized dedicated processor card. The gaming table CPU 52, typically includes a processor, memory, multiplex (“Mux”) card, video and Ethernet cards, power supply and an image acquisition card. While FIG. 4 shows a single centralized gaming table CPU 52, the monitoring system 50 can take a more distributed approach, locating dedicated processors in one or more of the individual system components. Alternatively, a common CPU could service a number of gaming tables, each of the gaming tables having a set of individual component subsystems. The gaming table CPU 52 communicates with external computers and devices over a communications link 54 such as a local area network (“LAN”) and/or a wide area network (“WAN”). The communications link 54 can be wired and/or wireless. The communications link can employ Internet, or World Wide Web communications protocols, and can take the form of a proprietary extranet.

A play tracking subsystem 56 visually monitors activity on the playing surface 20 of the gaming table 10. The play tracking subsystem 56 can be located in the chip tray 32, above the playing surface 20 of the gaming table 10. In other embodiments, as discussed in more detail below, the play tracking subsystem 56 can be located on the table just in front and proximate to the chip tray 32 or it can be located in an dealer's podium.

A chip tray monitoring subsystem 58 reads the machine-readable indicia 37 on the edge 35 of the chips 36 located in the chip tray 32. The chip tray monitoring subsystem 50 can be assembled with the chip tray 32 or assembled with the table 10 and thus attachable to the chip tray 32. In either embodiment, the chip tray monitoring subsystem 58 is configured to communicate with the play tracking subsystem 56. In one embodiment, the playing surface 20 includes an opening 60 for receiving a data link from the chip tray 30 to the chip tray monitoring subsystem 58. Details of reading (e.g., imaging) the chips located in the chip tray 32 can be found in U.S. Pat. No. 6,712,696, issued on Mar. 30, 2004.

The overall system 50 can be completed, at the casino's option, with a card verification subsystem 62, which contains optical hardware and/or software that identifies at least some of the cards in the card shoe 30 either before or as the cards are drawn from the card shoe 30. The particular details of the components used to optically image the playing cards in the card shoe 30 are found in U.S. Provisional Patent Application No. 60/500,898, filed on Sep. 5, 2003. The card verification subsystem 62 is within a housing of the card shoe 30 or is embedded in the table 10 as described in detail in U.S. Provisional Patent Application No. 60/511,931, filed on Oct. 16, 2003. Finally, the system 50 can optionally include a cash accounting and validation subsystem 64, which monitors the contents of the drop box 26 (FIG. 1).

Wagered Chip Tracking System

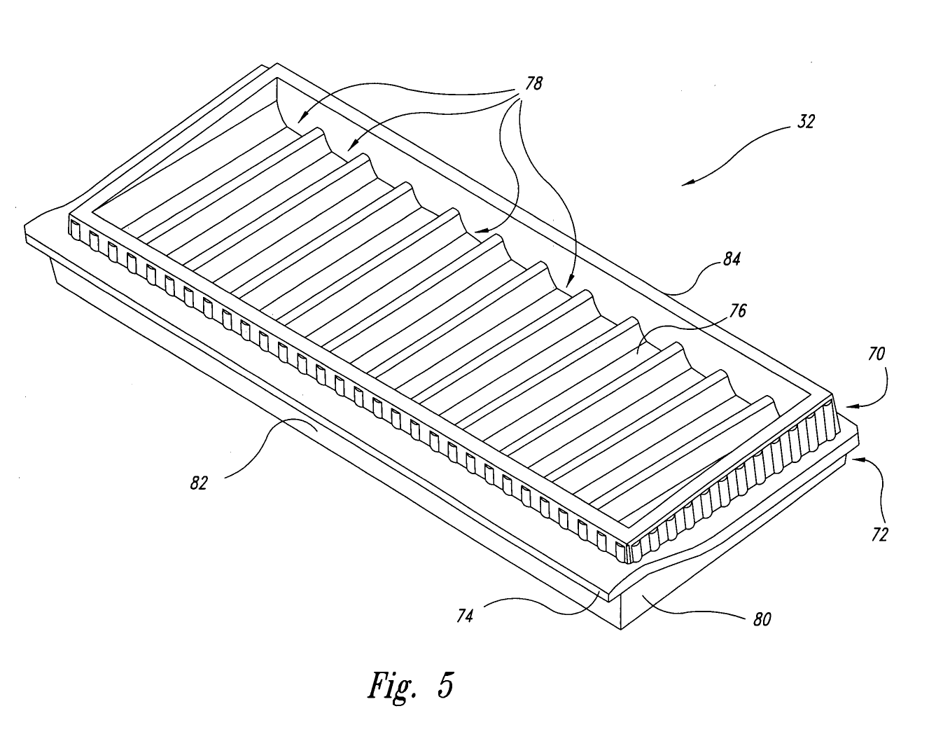

FIG. 5 illustrates a chip tray 32 having upper and lower portions 70, 72, respectively, and a shelf 74 separating the upper and lower portions 70, 72. The upper portion 70 includes a chip carrying surface 76 having a number of wells 78 sized and dimensioned to receive the chips 36 (FIG. 1). A sidewall 80 extends downwardly from the chip carrying surface 76 and thereabout to form a four-sided enclosure. The enclosure includes the optical and electrical components of the play tracking and chip tray monitoring subsystems 56, 58, respectively. When in use on a gaming table 10, a front portion 82 of the sidewall 80 faces the players 14 and a rear portion 84 of the sidewall 80 faces the dealer 12 (FIG. 1). The front portion 82 of the sidewall 80 is slightly higher than the rear portion 84, and the chip carrying surface 76 slopes slightly downward from the front to the rear. In one embodiment, the chip tray 32 is attached to the table 10 through a frame assembly (not shown), selectively attachable/detachable to the table 10, or merely contiguous, but unattached, to the table 10 during game play.

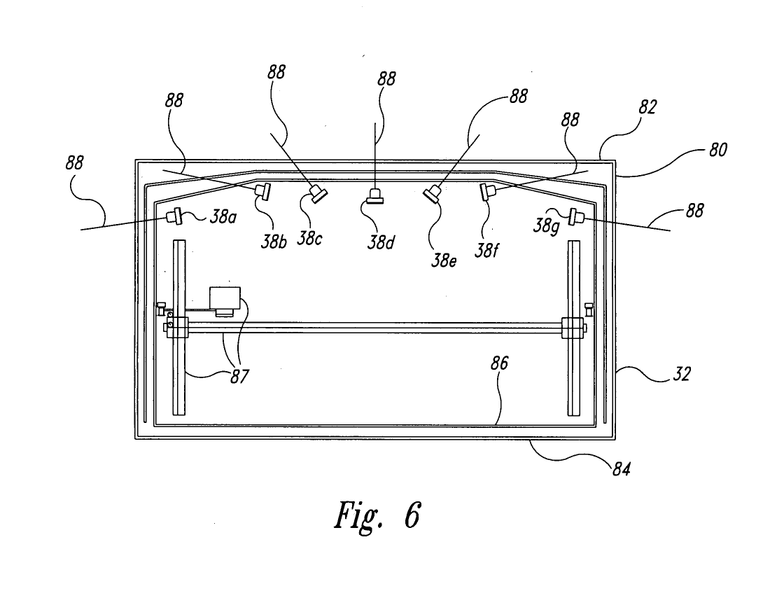

FIG. 6 shows a number of optical scanners 38 located within the chip tray 32. Specifically the optical scanners 38 are positioned within the enclosure formed by the sidewall 80 of the chip tray 32 to provide approximately 180° of coverage of the playing surface 20 from the perspective of the chip tray 32 according to the illustrated embodiment. In this embodiment, there are at least seven optical scanners 38, labeled as 38a through 38g. The optical scanners 38 are each mounted within a respective aperture 86 formed in the front portion 82 of the sidewall 80, below the shelf 74. Alternatively, the optical scanners 38 are aligned with the respective apertures 86.

In addition and as discussed above, an optical imaging system 87 (e.g., the chip tray monitoring subsystem 58 of FIG. 4) is located in the chip tray 32 according to the illustrated embodiment. The chip tray 32 is detachable from its frame, such that the frame and the optical devices remain in the table 10 after the chip tray 32 is removed therefrom.

Each optical scanner 38a through 38g includes an illuminator to project light onto the chips 36 and a light detector to receive at least some reflected light from at least the chip's edge 35. In one embodiment, the illuminator is a laser light source (e.g., laser diode). An electromechanical means, for example a micro-electrical mechanical system (means), operates to move the light along a scan path. The light detector is a photodiode, vidicon detector or equivalent device. It is understood that the illuminator and light detector can take on many forms that are known in the optical-electrical arts. In addition, it is understood that photo detectors generate an electrical signal that is proportional to an amount of light received from an object being read. The resulting signal may be an analog signal, in which an A/D converter is used to convert the analog signal to a digital signal to make the signal suitable for decoding. Tightly controlling the illuminating beam 88 is one way to adequately achieve sufficient resolution for effective reading and subsequent decoding of the machine-readable indicia 37 encoded on the chip's circumference (more detail on this provided below).

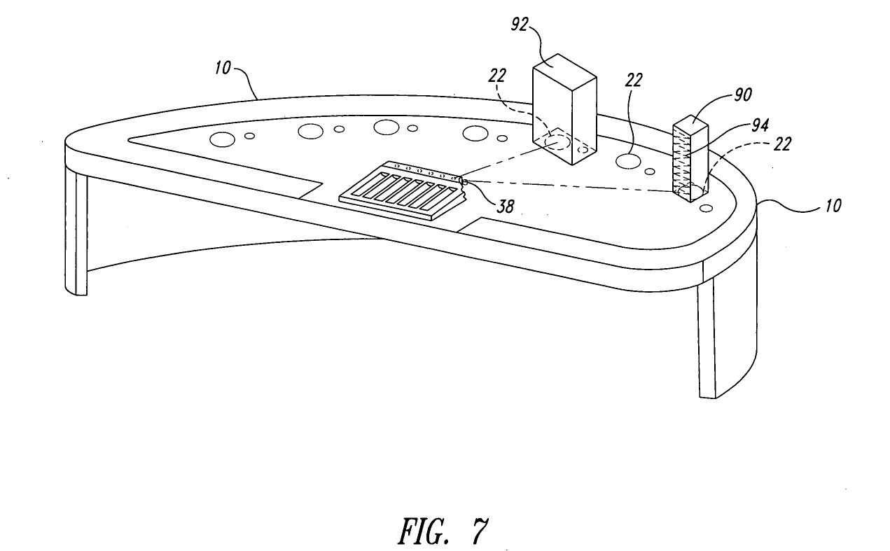

FIG. 7 shows the optical scanners 38 configured to read objects within a specified region. The specified region, for example, is a volume 90, which encompasses the wagering area 22, and/or a volume 92, which encompasses the wagering area 22 and the insurance wagering area 24. Even if the gaming table 10 does not have an insurance wagering area 24, the scanners 38 can be configured to read objects within the volume 92 because it may be expected that a player may not accurately place his or her chips 36 completely within the wagering area 22. The height of the volume 90, 92 is determined by an approximated height of a chip stack 36. Typically, one gaming chip 36 is approximately 0.25 inches thick and the chip stack 36 is usually not greater than six inches in height (i.e., twenty-four chips 36). If a chip stack 36 is taller than six inches, the casino personnel may request that the player reduce the height. Additionally or alternatively, more than one optical scanner 38 can be installed to read objects within a given area/volume of the gaming table 10. For example, dual scanners 38, one positioned on top of the other, could read the machine-readable indicia 37 on the chip stack 36 greater than six inches in height.

In one embodiment, the light 88 from the optical scanner 38 is aimable in a variety of directions by projecting the light 88 off a reflecting device such as an octagonal mirror. One skilled in the art will understand that the reflecting device can be controlled mechanically, electro-magnetically, electronically, hydraulically, etc. In addition, software modules can be used to control the direction, waveform, intensity, etc. of the light 88.

It is understood that a horizontal orientation of the machine-readable indicia 37 is established because of the chips 36 being placed on a flat table surface 20. However, because the rotational orientation about the chip's cylindrical axis is not known, the overall width of the machine-readable symbol 37 encoded onto the edge 35 of the chip 36 should be small enough to permit at least one set of bars and spaces, for example, to be read by the scanner 38. In one embodiment, the scanner 38 is configured to automatically recognize and decode certain symbols with appropriate decoding algorithms or methods, typically referred to as auto-discrimination. One possible advantage of using optical scanners 38 distally located from the wagering areas is that the scanners 38 do not interfere with the gaming environment. Another possible advantage is that optical scanners have a greater symbol-to-scanner distance than still and/or video imagers.

FIG. 8 illustrates a Depth of Field (“DOF”) for the optical scanner 38 is configured to restrict the depth over which the scanner 38 can effectively operate. The DOF defines a range of reading distances that a machine-readable symbol 37 can be effectively scanned and decoded. The casino can calibrate, adjust, or originally specify that the optical scanners 38 should have a desired DOF.

At the blackjack gaming table 10, for example, the scanner 38 is configured with a DOF to read and decoded a chip stack 36 that is located at a distance of about fourteen to about eighteen inches from the scanner 38. The scanner 38 rejects light that received from objects outside of the DOF. For example, the scanner 38 can reject light reflected from a striped shirt of a player. One skilled in the art will understand that the DOF can be less than or greater than four inches.

In one embodiment, an EV10 scan engine manufactured by Intermec Corporation in Everett, Wash. is sufficiently sized to fit within the confines of a chip tray 32 and yet provide a large DOF. The EV10 scan engine can read and decode distantly located symbols, poorly printed symbols, symbols having low contrast, or even symbols located in poor light conditions with sufficient accuracy. In addition, the EV10 scan engine may be configured to operate over a desired range and scan up to a sufficient height, for example a chip stack 36 of at least four inches in height. Further, the EV10 scan engine can operate with a DOF that effectively excludes or rejects light reflected from objects outside of a defined region (i.e., light reflected from objects located outside of the volumes 90 or 92).

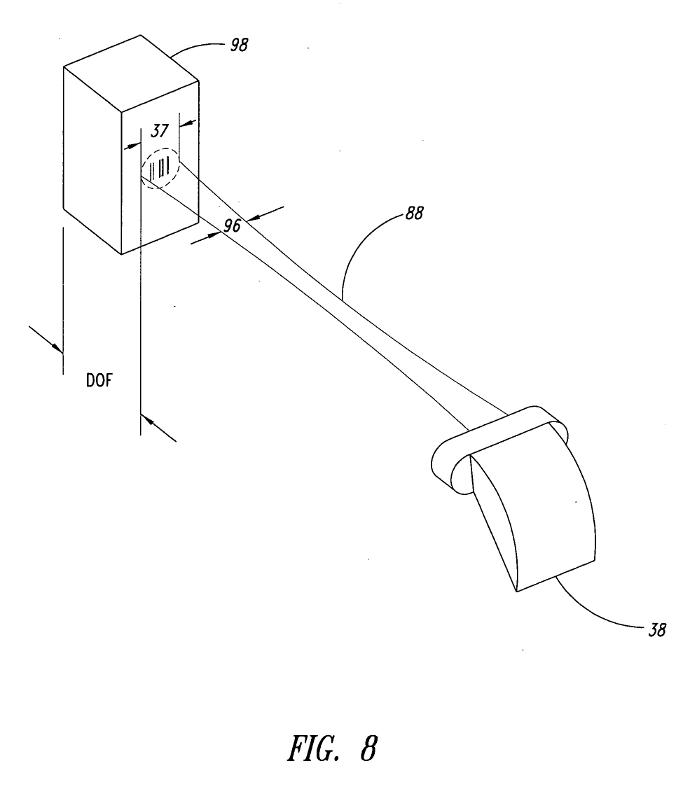

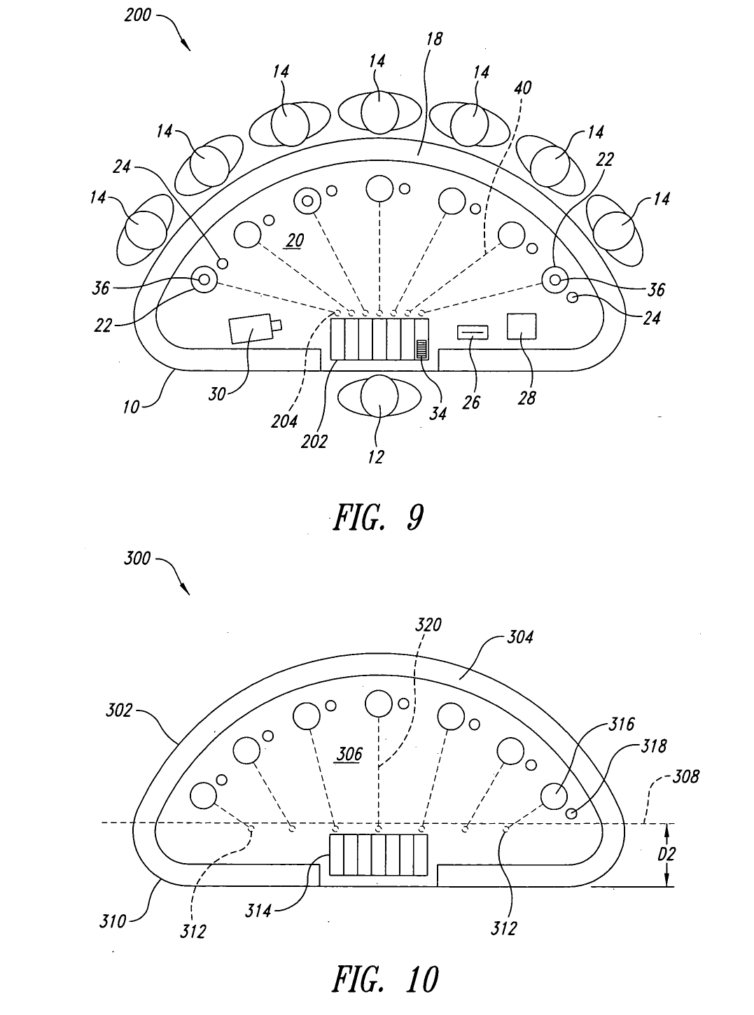

FIG. 9 illustrates another embodiment of a gaming environment 200 where the optical scanners 204 are coupled to the table surface 20. A chip tray 202 is located behind the optical scanners 204, closer to the dealer. In the present embodiment, it is understood the optical scanners 38 are distally located from the wagering areas 22.

As discussed above, the optical components comprising the optical scanner 38 can be located within the chip tray. Thus, if the chip tray 32 is removed from the gaming table, for example during a change of dealers 12 or a shift change, the optical components are not left exposed and/or visible in the gaming table. In contrast, it may be equally advantageous to have the optical components of the scanners 38 be separable from the chip tray 32. In this embodiment, the optical components are left embedded in the gaming table when the chip tray is removed. One reason for this embodiment is that damage to the optical components can be minimized by not having them be portable with the chip tray.

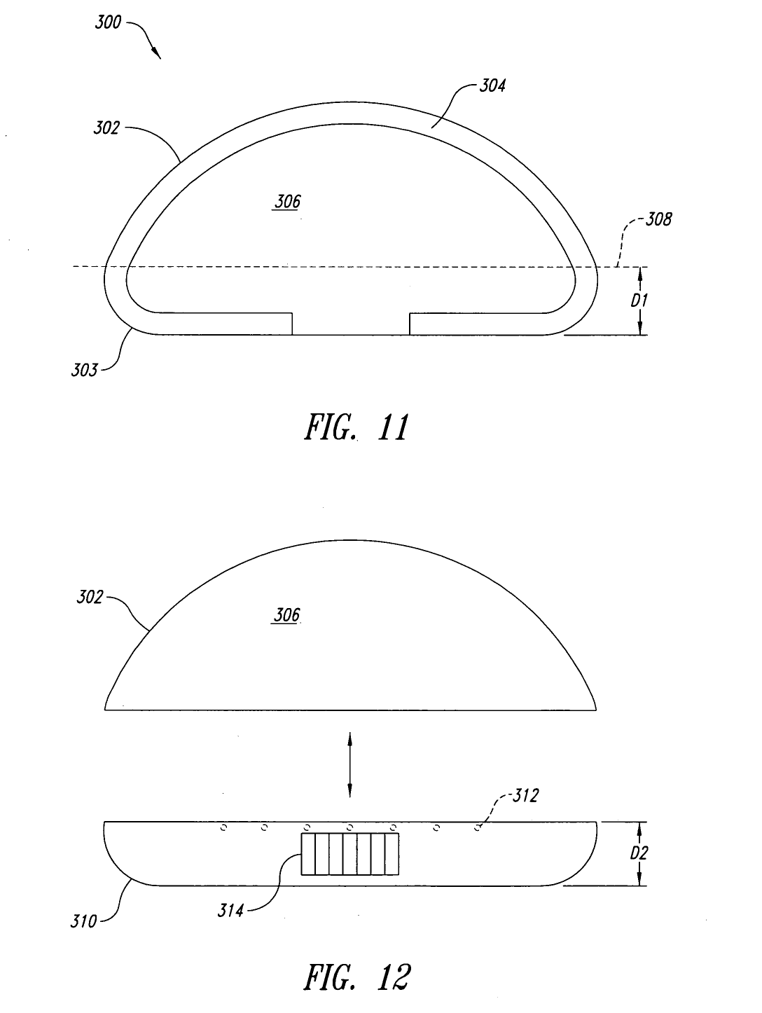

FIGS. 10 and 11 show an automated gaming environment 300 where optical scanners 312 are located in an auxiliary unit or dealer's podium 310. In one embodiment, the gaming table 302 includes a number of non-automated -elements and/or features associated with gaming, for example, the gaming table 302 includes a padded rail 304, a table surface 306, and printed areas 316 and 318 that identify betting circles 316 and/or insurance betting circles 318. The dealer's podium 310 is abutted against or attached to the gaming table 302. The dealer's podium 310 includes the optical scanners 312 and/or other automated devices as described more fully below.

FIG. 12 shows a first portion 303 separable from the gaming table 302. The first portion 303 is depicted as having a depth of “D1” with a separation point occurring along line 308. The first portion 303 is removed from the gaming table 302, and, the dealer's podium 310 is attached to, or abutted against the gaming table 302. The dealer's podium 310 can have a depth “D2,” which can be different from the depth “D1.” However, the depth “D2” should not differ significantly from the depth “D1” of the first portion 303 because the reach of the dealer 12 may be adversely impacted when the dealer 12 attempts to collect or distribute chips 36, cards, and/or currency, for example.

Referring back to FIG. 10, the dealer's podium 310 is configured with optical scanners 312 for reading a player's wager 36. Ideally, the alignment of the dealer's podium 310 with the gaming table 302 is accomplished so that the optical scanners 312 are sufficiently in line with the betting circles 316. However, it is possible that some adjustment of the optical scanners 312 may be necessary to achieve sufficient coverage of the wagering areas 316 located on the gaming table 302. While illustrated as being aligned with the centers of the betting circles 16 for ease of description, the optical scanner 312 may be aligned with other portions of the betting circles 316.

In another embodiment, the dealer's podium 310 includes an attachable/detachable automated chip tray 314 for imaging chips within the wells of the chip tray 314. In addition, the chip tray includes the optical scanners 38, similar to the illustrated chip tray of FIG. 1. Further, the dealer's podium 310 can include other automated devices such as a card shoe reader, discard reader, and/or drop box. Thus, the dealer's podium 310 allows a simple and inexpensive means of converting a non-automated gaming table into an automated gaming table 300.

The various embodiments described above can be combined to provide further embodiments. All of the above U.S. patents, patent applications, provisional patent applications and publications referred to in this specification, including, but not limited to U.S. Provisional Patent Application No. 60/517,297, filed on Nov. 3, 2003; U.S. Pat. No. 6,652,379, issued on Nov. 25, 2003; U.S. Pat. No. 6,685,568, issued on Feb. 3, 2004; U.S. Pat. No. 6,460,848, issued on Oct. 8, 2002; U.S. Provisional Patent Application No. 60/501,489, filed on Sep. 8, 2003; U.S. Pat. No. 5,782,647 to Fishbine et al.; U.S. Pat. No. 5,103,081 to Fisher et al.; U.S. Pat. No. 5,548,110 to Storch et al.; U.S. Pat. No. 4,814,589 to Storch et al., U.S. Pat. No. 6,514,140 to, Storch; U.S. Pat. No. 6,313,871 to Schubert; U.S. Provisional Patent Application No. 60/490,072, filed on Jul. 25, 2003; U.S. Pat. No. 6,712,696, issued on Mar. 30, 2004; U.S. Provisional Patent Application No. 60/500,898, filed on Sep. 9, 2003; and U.S. Provisional Patent Application No. 60/511,931, filed on Oct. 16, 2003, are incorporated herein by reference in their entirety. Aspects of the invention can be modified, if necessary, to employ various systems, devices and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all gaming monitoring systems and methods that operate in accordance with the claims. Accordingly, the invention is not limited by the disclosure, but instead its scope is to be determined entirely by the following claims.

We claim:

1. A wager monitoring system comprising:
a gaming table having at least one delimited area to receive at least one object bearing a machine-readable symbol; and
a scanner operable to receive light from the at least one object, if any, when the at least one object is located at least partially within a volume extending perpendicularly from the delimited area, the scanner further operable to produce a signal indicative of a reflectance profile of light, wherein the reflectance profile is resolvable if the light is received from the at least one object.

2. The wager monitoring system of claim 1 wherein the delimited area is a wagering area on a playing surface of the gaming table.

3. The wager monitoring system of claim 1 wherein the at least one object bearing the machine-readable symbol is a casino chip placed at least partially within the volume as a wager.

4. The wager monitoring system of claim 1 wherein the reflectance profile of light comprises an optical signal modulated with an amount of information from the machine-readable symbol.

5. The wager monitoring system of claim 1 wherein the scanner is operable to discriminate between light received from the at least one object and light received from another object located outside of the volume.

6. The wager monitoring system of claim 1, further comprising:
a light generating source located within the scanner to produce a beam of light, a rotatable reflector to direct the beam of light toward the volume; and
a detector to receive the light from the at least one object bearing the machine-readable symbol.

7. A method of reading information from a machine-readable symbol, the symbol carried by at least one wager, the method comprising:
locating at least one optical scanning device distally from a wagering area on a gaming table;
calibrating the optical scanning device to have a depth of field region configured to read the machine-readable symbol when the at least one wager is located approximately within the wagering area;
projecting a light source toward at least a portion of the at least one wager;
receiving at least some amount of light reflected from the at least one wager, the light modulated with information carried by the machine-readable symbol; and
processing the amount of reflected light to decode the information from the machine-readable symbol.

8. The method of claim 7, further comprising:
discriminating between light received from the at least one wager when the at least one wager is located approximately within the wagering area and light received from another object located outside of the depth of field region.

9. The method of claim 7 wherein locating at least one optical scanning device distally from a wagering area on the gaming table includes mounting the optical scanning device in a chip tray.

10. The method of claim 7 wherein locating at least one optical scanning device distally from a wagering area on the gaming table includes mounting the optical scanning device proximate to a chip tray.

11. The method of claim 7 wherein locating at least one optical scanning device distally from a wagering area on the gaming table includes mounting the optical scanning device in a fixture configured to be adjacently located to the gaming table.

12. A system for reading information from an object located on a gaming table, the system comprising:
at least one optical scanning device distally located from a wagering region on the gaming table, the optical scanning device calibrated to have a depth of field tailored to read a machine-readable symbol carried by the object when the object is located approximately within the wagering region; and
a processor communicatively coupled with the optical scanning device for processing at least some of the light reflected from the object.

13. The system of claim 12 wherein the object is a stack of gaming chips.

14. The system of claim 12 wherein the at least one optical scanning device is operable to discriminate between light reflected from the object located approximately within the wagering region and light reflected from another object located outside of the wagering region.
